(19) United States
(12) Patent Application Publication
(10) Pub. No.: US 2016/0051965 A1
(43) Pub. Date: Feb. 25, 2016

(54) ABSORBANT AND DIGESTER FOR CARBON-BASED SUBSTANCES SUCH AS OIL

(71) Applicant: Jeff R. Angel, Mt. Vernon, IN (US)

(72) Inventor: Jeff R. Angel, Mt. Vernon, IN (US)

(21) Appl. No.: 14/830,723

(22) Filed: Aug. 19, 2015

Related U.S. Application Data
(60) Provisional application No. 62/038,894, filed on Aug. 19, 2014.

(51) Int. Cl. B01J 20/22

(52) U.S. Cl. CPC B01J 20/22

(57) ABSTRACT

A carbon-containing emulsion cleaning and digesting medium comprising: 60% beet pulp shreds with molasses, 25% proprietary blend of bacteria 15% water crystals by weight. A user of this medium sprinkles it in a layer upon an area such as a concrete floor contaminated by a spilled emulsion or substance which contains carbon in its molecular structure, such as oil, and then moistens it until no more water can be absorbed. This medium is left to digest the spill overnight or longer to the elimination of the substance it is intended to absorb. The product itself is nontoxic and remaining product and any byproduct of the digestion of the spill is nontoxic as well.

### FIELD OF THE INVENTION

The present invention relates to oil absorbing media which are used by garages and shops, as well as industries which routinely require cleaning or absorbing of spilled oil, or any type of substance which has carbon in its constitution. It more specifically relates to media which not only absorb oil or other carbon-based substances, but digest it, leaving inert material to be disposed of like compost or household waste. The media of the present invention can also be used for cleaning or absorbing any organic or inorganic material.

### BACKGROUND OF THE INVENTION

Oil absorbers available to the public or on commercial levels generally consist mostly of bentonite which is placed upon the spilled oil residue. After the oil is absorbed, the bentonite-oil waste material must be taken to a land-fill for proper disposal. It is obvious that a more desirable solution to disposal of oil and oil-spill clean-up should be sought-out due to the increasing environmental regulations targeting the population's need to reduce the toxic load on our planet. Various situations from home and commercial to industrial use can benefit from eliminating hazardous waste resulting from oil spills.

### SUMMARY OF THE INVENTION

The present invention is a cleaner, a digesting medium which cleans (digests) spilled oil (or any emulsion which contains carbon in its molecular structure) from surfaces or within vessels. Once the spill clean-up process with the present invention is complete, there is no toxic residue to dispose of. It is an “environmentally-safe”, “biodegradable” and non-hazardous product. Its action is digestion of a carbon-source: spilled or leaked oil, waste oil, any emulsions containing carbon in their molecular structures: examples of which could be anything from pharmaceuticals to other biological liquids such as wine or blood.

According to one aspect of the present invention, there is provided a substance for removing carbon-based waste matter from a surface or container comprising a mixture of a plurality of pieces of absorbing media; a plurality of pieces of digesting media interspersed with said absorbing media; and a plurality of pieces of water retaining material interspersed with said absorbing media and said digesting media. The mixture preferably comprises 60% absorbing media, 25% digesting media, and 15% water retaining material. The absorbing media may also serve as a food source for the digesting media.

The absorbing media according to one preferred embodiment is comprised of beet pulp shreds. The absorbing media may further comprise molasses mixed with the beet pulp shreds. The digesting media may comprise bacterial agents and/or fungal agents or a mixture of both. The digesting bacterial agents may comprise facultative bacillus and the digesting fungal agents may comprise fungal strains. The digesting media may further comprise an organic oxygenating agent. The water retaining material may comprise a plurality of water absorbing crystals. The mixture preferably comprises 60% beet pulp shreds with molasses, 25% blend of bacterial agents and fungal agents, and 15% water retaining crystals.

According to a further aspect of the present invention there is provided a substance for removing carbon-based waste matter from a surface or container comprising a mixture of a plurality of pieces of beet pulp shreds with molasses which act as an absorbing material and a source of nutrition; a mixture of bacterial and fungal agents which act as a digesting agent interspersed with said beet pulp shreds; and a plurality of water retaining crystals interspersed with said beet pulp shreds and said mixture of bacterial and fungal agents. The mixture according to this aspect of the invention may further include an organic oxygenating agent. The mixture preferably comprises 60% beet pulp shreds with molasses, 25% blend of bacterial agents and fungal agents, and 15% water retaining crystals.

The advantages of the present invention over the traditional bentonite oil absorbing products or land-filling of toxic substances which have carbon within their molecular structures are great. Its composition is simple. It is easy to use. It is made from inexpensive, nontoxic, light-weight and easy-to-obtain components. It quickly and efficiently it disposes of a toxic substance, leaving only a biodegradable, non-toxic byproduct. Applications of the present invention range from individual home use to industrial use, as well as indoors to outdoors, land or aquatic.

One aspect of the present invention is a biodegradable combination of a cellulose material, a blend of bacteria and/or fungi, and water-absorbing crystals.

The cellulose material serves as an absorbing medium for both water and the targeted waste liquid and a carrier and an infrastructure and food supply for the bacterial and/or fungal digesters. The cellulose material absorbs the waste liquid as well as water when wetted by application of water to the medium. The cellulose material is essential to providing the digesters enough “room and board” to adapt to the target material they are set-to. According to one preferred embodiment of the present invention, the cellulose material comprises a mixture of shredded beet pulp and molasses. Alternatively, other organic polymers possessing the desired characteristics can be used in place of the cellulose material. For example, sodium-based acrylamides, potassium-based acrylamides, alfalfa, or other potato, corn or starch based material may be used.

The blend of bacteria and/or fungi functions to digest the carbon-based substance. According to one aspect of the present invention, the blend of bacterial and fungal strains contain the digesters: a blend of facultative bacillus and fungal strains with an organic oxygenating agent. According to one aspect of the present invention, the bacteria/fungi blend is a blend of primarily aerobic organisms. The blend may also contain a bacteria-friendly, time-releasing oxidizing agent that will accelerate the bacterial action of the organisms. According to one presently preferred embodiment, the bacteria/fungi blend is a unique blend of laboratory-enhanced, naturally-occurring, primarily aerobic organisms manufactured by the Cape Cod Biochemical Company under the name AfterShock™. AfterShock™ also contains a proprietary, bacteria-friendly, time-release oxidizing agent that will accelerate the bacterial action of the organisms in the product.

The water absorbing crystals keep the mixture moist in order to sustain a positive biological environment for the digesters to do their work.

### DETAILED DESCRIPTION OF THE PREFERRED EMBODIMENTS

The present invention is an oil-absorbing and digesting media which completely cleans the oil-soaked area, such as a garage or shop floor. Leftover mixture can be disposed of without land-filling, or can be recycled by the user for repeated uses until the media composts itself completely into an inert earth-like material. The media of the present invention cleans the area very effectively of the hazardous spilled substance, leaving only inert, benign residue which may be cleaned from a concrete floor with soap and water if desired, or swept away as appropriate to the environment.

The present invention is a digestive medium which is to be used to consume any type of carbon-containing waste matter which may or may not be hazardous to the environment. It works through the digestive action of bacterial and fungal strains combined with water-retaining crystals mixed into a nutritive carrier (the beet pulp). When digestion of the oil is complete, what is left is a small amount of dirt, water and the remainder of the unused mix.

According to one presently preferred embodiment, the present invention is an absorbent and digester for carbon-based substances comprising a mixture of three basic separate components: beet pulp with molasses, a proprietary blend of “oil-eating” bacteria, and water-absorbing crystals. According to this presently preferred embodiment, the mixture is composed of 60% beet pulp shreds with molasses, 25% proprietary blend of bacteria and 15% water crystals by weight.

The beet pulp shreds with molasses medium serves as an absorbing medium for both water and the targeted waste liquid and a carrier and an infrastructure and food supply for the bacterial and fungal digesters. The beet pulp shreds absorb the waste liquid as well as water when wetted by application of water to the medium. The beet pulp is essential to providing the digesters enough “room and board” to adapt to the target material they are set-to.

The proprietary blend of bacterial and fungal strains contain the digesters: a blend of facultative bacillus and fungal strains with an organic oxygenating agent.

The water crystals in this mixture keep the mixture moist in order to sustain a positive biological environment for the digesters to do their work.

In use, the media of the present invention is sprinkled upon the area one wishes to clean (such as a heavily soaked area prone to oil spillage on a shop floor). The user then moistens the media of the present invention with water to maximum absorption. Thereafter, the medium should be kept moist until the full digestion of the spill is complete to the satisfaction of the user. Spills are generally cleaned satisfactorily within 12-24 hours. Additional applications of the media of the present invention can be extended to longer periods where deeper saturations have accumulated over a period of years. The media that remains can be retained and reused or added to a compost pile, or disposed of as biodegradable rubbish.

If the spill has occurred in an area exposed to direct sunlight for long periods, the treated area may be covered with an opaque cover such as a tarp to retain moisture to prevent need for repeated re-moistenings. The beet pulp possesses light-shielding properties, however the proprietary bacterial and fungal strains do not flourish in bright sunlight or when dehydrated, and applications in bright sunlight may have to be thicker and moistened more often if not covered.

Industrial use of the media of the present invention to remediate extremely large oil spills on land will proceed in the same fashion as on a small scale, however, surface environment such as sand, rock, or earth and ambient weather would be considered. Removal of vast quantities of earth would not be required due to effective decontamination of the ground. The media of the present invention has further been tested in connection with the removal of inorganic materials such as salt from the earth and has been found to be effective. It is also anticipated that water can be added to the mixture to create a liquid based media which can be applied with a sponge or other applicator. Aquatic uses of the media of the present invention have not yet been tested, however, due to the nature of this product, but are contemplated. It is likely that it may prove to be a viable oil-digesting agent while being floated on top of the water.

The foregoing is provided for purposes of illustrating, explaining, and describing embodiments of the present invention. The specific components and order of the steps listed above, while preferred is not necessarily required. Further modifications and adaptation to these embodiments will be apparent to those skilled in the art and may be made without departing from the scope or spirit of the invention.

I claim:

1. A substance for removing waste matter from a surface or container comprising a mixture of:
a plurality of pieces of absorbing media;
a plurality of pieces of digesting media interspersed with said absorbing media; and
a plurality of pieces of water retaining material interspersed with said absorbing media and said digesting media.

2. The substance of claim 1 wherein the mixture comprises 60% absorbing media, 25% digesting media, and 15% water retaining material.

3. The substance of claim 1 wherein the absorbing media also serves as a food source for the digesting media.

4. The substance of claim 1 wherein the absorbing media is comprised of beet pulp shreds.

5. The substance of claim 4 wherein the absorbing media further comprises molasses mixed with said beet pulp shreds.

6. The substance of claim 1 wherein the digesting media comprises bacterial agents.

7. The substance of claim 6 wherein the digesting media further comprises fungal agents.

8. The substance of claim 7 wherein the digesting bacterial agents comprise facultative bacillus and the digesting fungal agents comprise fungal strains.

9. The substance of claim 8 wherein the digesting media further comprises an organic oxygenating agent.

10. The substance of claim 5 wherein the digesting media comprises bacterial agents.

11. The substance of claim 10 wherein the digesting media further comprises fungal agents.

12. The substance of claim 11 wherein the digesting bacterial agents comprise facultative bacillus and the digesting fungal agents comprise fungal strains.

13. The substance of claim 12 wherein the digesting media further comprises an organic oxygenating agent.

14. The substance of claim 1 wherein the water retaining material comprises a plurality of water absorbing crystals.

15. The substance of claim 13 wherein the water retaining material comprises a plurality of water absorbing crystals.

16. The substance of claim 15 wherein the mixture comprises 60% beet pulp shreds with molasses, 25% blend of bacterial agents and fungal agents, and 15% water retaining crystals.

17. A substance for removing waste matter from a surface or container comprising a mixture of:
a plurality of pieces of beet pulp shreds with molasses which act as an absorbing material and a source of nutrition;
a mixture of bacterial and fungal agents which act as a digesting agent interspersed with said beet pulp shreds; and
a plurality of water retaining crystals interspersed with said beet pulp shreds and said mixture of bacterial and fungal agents.

18. The substance of claim 17 wherein the mixture further includes an organic oxygenating agent.

19. The substance of claim 17 wherein the mixture comprises 60% beet pulp shreds with molasses, 25% blend of bacterial agents and fungal agents, and 15% water retaining crystals.

20. The substance of claim 17 wherein the mixture further comprises water.
